(19) United States
(12) Patent Application Publication
(10) Pub. No.: US 2007/0282902 A1
(43) Pub. Date: Dec. 6, 2007

(54) ACCESSING AND PURCHASING OF MP3 FILES AND PLAYLISTS FROM PROVIDER SOURCES VIA COMMUNICATION NETWORKS

(76) Inventors: LEUGIM A. BUSTELO, Austin, TX (US); Merle Douglas Sterling, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/421,106

(22) Filed: May 31, 2006

(51) Int. Cl. G06F 17/00

(52) U.S. Cl. 707/104.1

(57) ABSTRACT

Enabling a user to selectively branch, at a selected MP3 file departure node in a playlist sequence being played, to sequentially playing a second playlist of stored MP3 files arranged according to an attribute different from the attribute that determined the original playlist and storing the departure node. In response to the user selection of such a branch, there is accessed from a source in a communications network (Web), this second playlist of a sequence of stored MP3 files arranged according to the second attribute and the user is enabled to return to the departure node to continue the playing of the first playlist from the departure node. The source of the files in this second playlist may be a provider of such files and/or playlists for purchase.

### CROSS-REFERENCE TO RELATED PATENT APPLICATION

The following copending patent application, which is assigned to the same assignee as the present invention, covers subject matter related to the subject matter of the present patent application: Application (Attorney Docket No. AUS920060124) filed on the same date as the present Application, entitled: MP3 Playing with Simplified User Interactive Generation and Navigation of Playlists, L. A. Bustelo et al., and hereby incorporated by reference.

### TECHNICAL FIELD

The present invention relates to the playing of music files on MP3 players, and particularly to simplified generation and navigation through MPE playlists of files available from MP3 music file providers.

### BACKGROUND OF RELATED ART

Over the past few years, the consumer electronics industry has witnessed an unprecedented demand for MP3 players and the music titles or MP3 files playable in sequences, i.e. playlists on such players. By music titles or MP3 files is meant recorded musical presentations from two or three minute tunes or units up to and including usually album-sized recordings in the order of one hour in length. MP3 is shorthand for MPEG, Level 3. MP3 is, to a great extent, replacing the Compact Disc as today's reigning music distribution standard with dozens of MP3 player devices saturating the consumer marketplace. MP3 is a standard about which an industry has been gathered. MP3 takes advantage of the high compression afforded under the MPEG audio standard and uses it as the basis for a file system, which serves as a standard for today's MP3 hardware. The advantage of MP3 is simply compression. It fits audio files into about 1/20 of the space raw digital audio would require. As a result, music that would nominally require a 50 MB file under the WAV format only takes about 2-3 MB. Smaller files mean less transmission time so that entire albums can reasonably be sent across the Internet. In solid state memory MP3 players, substantial lengths of music (a few hours or more) may be encoded into the solid-state memory and carried about in a no-moving-parts player, such as the iPod™. It is these solid memory players that are today's MP3 music title portable players. Better still, by squeezing the size of the MP3 file, the data rate required for playing back a file in real-time can be similarly reduced. Instead of requiring the approximately 1.2 mbits/sec to move two CD-quality audio channels, MP3 files need only 40 kbits/sec for near-CD-quality playback. In the most popular MP3 players, the MP3 music titles or files are currently stored in solid state memories with a capacity in the order of 1 gigabyte (GB) that equates to about 240 tunes or songs or about twenty CDs. For users requiring an even greater capacity, the memory in the MP3 player may be supplemented by a compact hard disk drive incorporated into the player that increases capacity in the order of 10 to 50 gigabytes.

All of this great capacity for music files or titles presents the user carrying his little MP3 player, even with backup on his correlated desktop, with the burden of riches. He is virtually carrying a huge library of music files on his back. The MP3 industry has the task of enabling the user, particularly of a portable MP3 player, to conveniently sort or navigate through his potentially huge library of stored MP3 files together with the hundreds of music files that become available every day for acquisition and purchase to locate, acquire and play the files that he desires at a particular time without having the burden of the navigation, generation and purchase of such MP3 files and playlists intruding upon the pleasure of his listening.

By way of background, the latest state of the art MP3 playing devices such as the iPod™, their relationship with their correlated desktops, and the acquisition of MP3 files and playlists via the Internet or World Wide Web (Web) from sellers of such files is simply described in the 2006 text, iPod™+iTunes™ for Windows™ and Mac™ in a Snap, Brian Tiemann, Sams Publishing, Indianapolis, Ind.

### SUMMARY OF THE PRESENT INVENTION

The present invention provides an implementation that enables a user of an MP3 player to conveniently sort or navigate through his potentially huge library of stored MP3 files together with the hundreds of music files that become available every day for acquisition and purchase to locate, acquire and play the files and playlists of files that he desires to play with an option to acquire, at a particular time, without having the burden of this navigation, access and purchase intruding upon the pleasure of his listening.

The invention is directed to conventional means for sequentially playing a first playlist of a sequence of a plurality of stored MP3 files arranged according to a selected attribute of the files. There is provided the combination of means enabling a user to selectively branch, at a selected MP3 file departure node in the sequence, to sequentially playing a second playlist of a sequence of a plurality of the stored MP3 files arranged according to an attribute different from the selected attribute, together with means for storing the departure node. The present invention provides, in response to the user selection of such a branch, means for accessing from a source in said communications network, this second playlist of a sequence of stored MP3 files arranged according to the second attribute and means for enabling the user to return to the departure node to continue the playing of the first playlist from departure node. The source of the files in this second playlist may be a provider of such files and/or playlists for purchase.

According to a further aspect of the invention, there are further means enabling a user to selectively branch, at a selected second departure node in the second playlist sequence, to sequentially playing a third playlist of a sequence of a plurality of the stored MP3 files arranged according to an attribute different from the attribute of the second playlist, together with means for storing the second departure node. In response to the user selection of such a further branch to a third playlist, the invention provides means for accessing from the above source in the communications network, e.g. Web, this third playlist of a sequence of stored MP3 files arranged according to the third attribute and means for enabling the user to return to selected departure node to continue playing the departed playlist from the departure node. Of course, any of the branched to playlists of files would be similarly available for acquisition or purchase from the provider via the Web.

In accordance with an aspect of the invention, means are provided for playing, in a sample mode, any of the branched to playlists of MP3 files acquired from providers so that the user has the option of moving faster through MP3 files of less interest.

While the above functions have been described with respect to individual attributes determining the playlists, a set of a plurality of attributes may be used to define or determine the playlists.

It should be noted that the term MP3 files has been used herein to cover compressed digital media, e.g. audio file, currently in popular usage to create playlists. MP3 files are lossy compression files. Other equivalent compressed files that may be used are ACC, a lossy compression file used by Apple Corp., WMA, a lossy compression file used by Microsoft, and WAV, a lossy-less compression file common in devices with Windows implementations.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a network (Web) portion, i.e. an MP3 connected to desktop computer, connected to the Web via a server to illustrate how the present invention accesses branched to playlists of MP3 files from provider sources via the Web;

FIG. 2 is a diagrammatic illustration of the system for controlling an MP3 player device that may be used in the practice of the present invention;

FIG. 3 is a block diagram of a data processing system including a central processing unit and network connections via a communications adapter that functions as the desktop computer display station through which a connected MP3 player may access branched to playlists of MP3 files from provider sources via the Web;

FIG. 4 is the user interface portion of a conventional portable MP3 player device that may be used in the practice of the present invention;

FIG. 5 is the display screen on a conventional MP3 player displaying several attributes of an MP3 file being currently played from a playlist;

FIG. 6 illustrates a display interface that was brought up when a viewer or user at a portable MP3 player wished to branch from the playlist being played (determined by an initial selected attribute) to another playlist, provided by an MP3 file provider and determined by a different attribute selected from the attributes of the MP3 file being played in FIG. 3;

FIG. 7 is an illustrative flowchart describing the setting up of the programming functions to form the implementation of enabling a user to selectively branch from a selected MP3 file departure node in a sequence (playlist) to a second playlist, provided by an MP3 provider, and arranged based upon a different attribute in accordance with the present invention; and

FIG. 8 is a flowchart of an illustrative run of the program set up according to FIG. 7.

### DETAILED DESCRIPTION OF THE PREFERRED EMBODIMENT

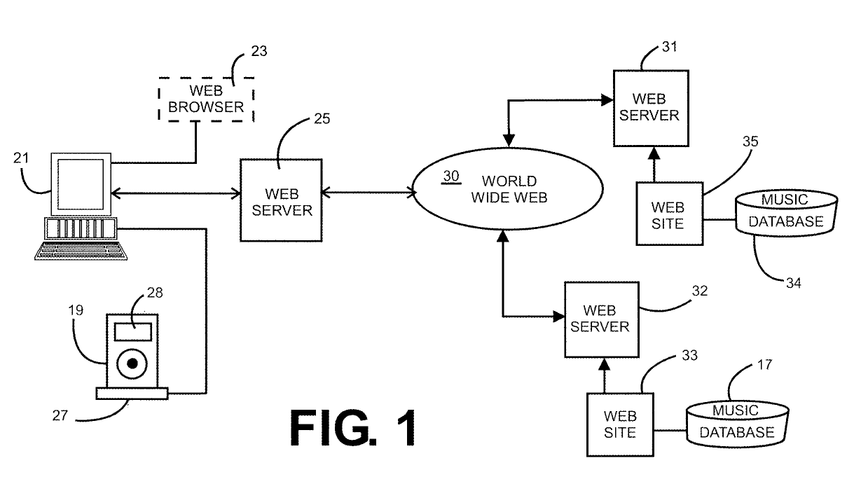

Referring to FIG. 1, a generalized example of the practice of the present invention involves a generalized portion of the Web that serves as the illustrative communication network in this embodiment of the present invention. MP3 player 19, with display 28, e.g. an iPod™, is connected to dock 27, which in turn is connected to and synchronized with desktop computer 21, which in turn is connected to the Web 30 through its Web server 25 so that a user of computer 21 may navigate on the Web 30 under the control of the Web browser program 23 in the desktop 21. The docking connection is a high-speed FireWire or USB 2.0 connection. The docking and connection to the desktop is described in greater detail at pp. 162-163 of the above text, iPod™+iTunes™ for Windows™ and Mac™ in a Snap. The synchronization and loading between the computer 21 and the MP3 player 19 is described in Chapter 6, pp. 161-198, of the text. When the branched to playlists are subsequently described, it will be understood that desktop computer 21 under control of a conventional Web browser 23 obtains the playlists of MP3 files from MP3 file provider databases 34 or 17, at provider Web sites 35 and 33, respectively, accessed through their Web servers 31 and 32.

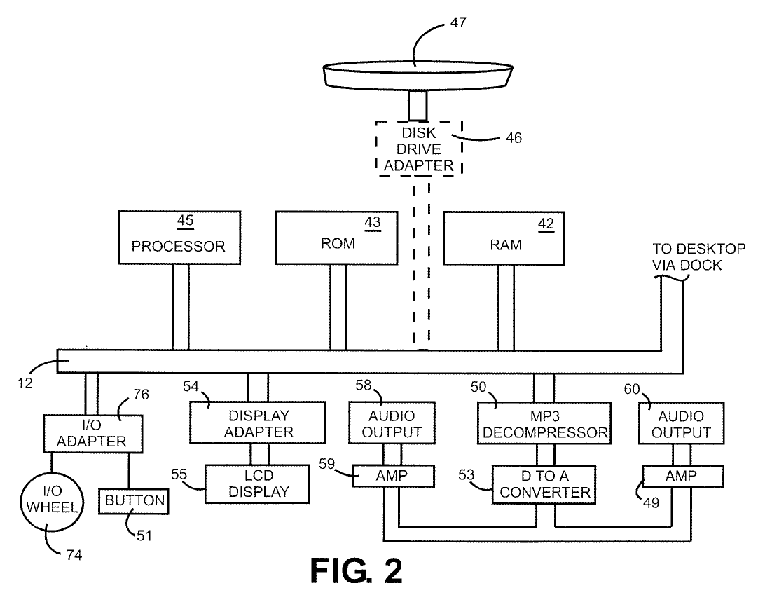

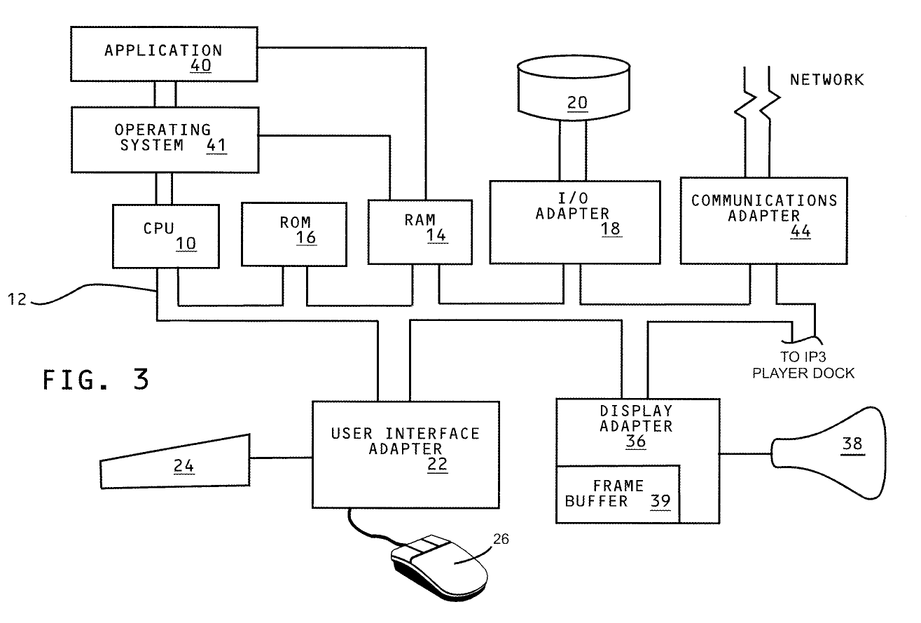

At this point, a typical desktop computer that may be used in the practice of the invention will be described with respect to FIG. 3. A central processing unit (CPU) 10, such as one of the PC microprocessors or workstations available from International Business Machines Corporation (IBM) or Dell PC microprocessors, is provided and interconnected to various other components by system bus 12. An operating system 41 runs on CPU 10, provides control and is used to coordinate the function of the various components of the computer of FIG. 2. Operating system 41 may be one of the commercially available operating systems, such as IBM's AIX or Microsoft's WindowsXP™ or Windows 2000™, as well as UNIX and other IBM AIX operating systems. Application programs 40, controlled by the system, are moved into and out of the main memory Random Access Memory (RAM) 14. These programs include search programs of the present invention for accessing playlists of MP3 files branched to by the user playing MP3 files in the MP3 player device. These functions, which will be described hereinafter, will access the Web controlled by conventional Web browsers (browsers 23, FIG. 1) at Web display stations 21 (FIG. 1), such as Microsoft's Internet Explorer™.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage drive 20. Communications adapter 44 interconnects bus 12 with an outside network, e.g. the Web. Bus 12 is also connected to the MP3 player dock (27, FIG. 1). I/O devices are also connected to system bus 12 via user interface adapter 22 and display adapter 36. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

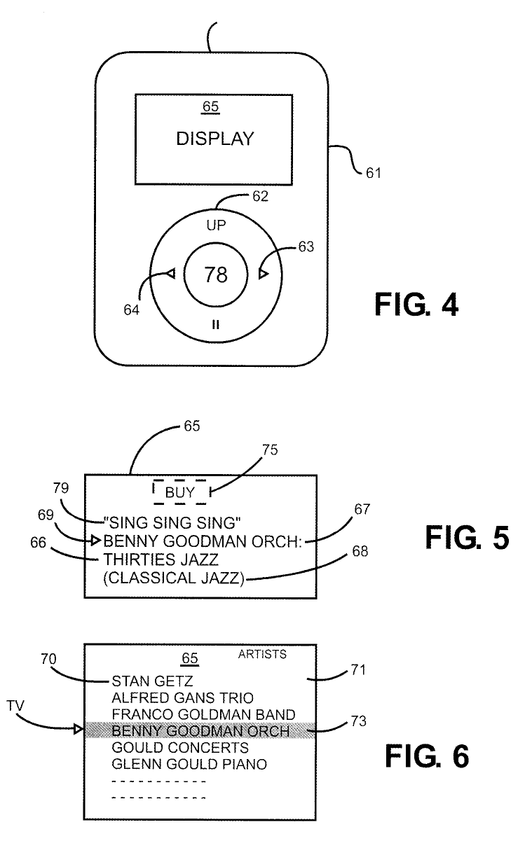

Referring now to FIG. 2, a typical system is shown that may function as the system for the conventional players for MP3 files on which the present invention may be implemented. For purposes of the present illustration, the MP3 player will be a portable handheld type player, such as the iPod™. The control system for the player system may be embodied in the controller integrated circuit chips within the player housing that may provide specific purpose logic to control the access and logic as follows. These logic or control chips contain data processors 45, operating systems stored in RAM 42 (about 2 MB of RAM is typically provided) and a ROM 43 that provides the primary programmable memory. This programmable ROM may be an EEPROM, e.g. flash EEPROM. All of the routines and programs that control the player may also conventionally be stored in this flash EEPROM 43. These include operating systems and built-in applications that may also conventionally be stored in the RAM. The program of the present invention may conveniently be included in this EEPROM. The logic or controller chip also contains the system bus 12 connecting the elements of the invention. The player is powered by a conventional portable power supply (not shown) that is connected through the system bus 12. Under the control of processor 45, the content, i.e. MP3 files stored in ROM 43 (EEPROM up to 1 gigabyte), are to be played under the control of programs, such as that of the present invention that may also be stored in ROM 43 or in RAM 42. In the higher storage content MP3 player devices, there may be a supplementary portable disk drive storage in hard drive 47 connected to bus 12 through disk drive adapter 46. In any case, the stored MP3 files are moved via bus 12 from storage to RAM 42 wherein the playlists are formed and sequentially played. The MP3 data is decompressed through decompressor 50. The decompressor 50 may be included in the above-described logic or control chip. The decompressed digital data representative of the MP3 file being presented is put through a digital to analog converter 53 and then coupled to audio output devices 58 and 60, respectively, through amplifiers 49 and 59. The audio output may be in the form of speakers or conventional earphones. The conventional user interface through which the present invention may be implemented includes a conventional finger operated I/O wheel 74 and associated buttons 51 (subsequently described relative to FIG. 4) connected via I/O adapter 76 to bus 12, as well as LCD display 55 connected via display adapter 54.

Referring now to FIG. 4, the present invention will be described with respect to a portable MP3 file playing device such as the iPod™. However, it should be understood that while the benefits of the present invention are most advantageous to portable players, the ease of use conveniences in the navigation through MP3 playlists are also effective in stationary players such as the above-described desktop computers with Apple or Windows operating systems. MP3 player 61 has LCD display 65 and I/O selection wheel 62 that may be rotated as shown in navigating through menus of selections while center button 78 is pressed to make the selections. The wheel also contains a set of push points, i.e. buttons: up 62 for advancing through a set of menus, and points 63 and 64 for stepping back and forward respectively. It also has a pause (11) point.

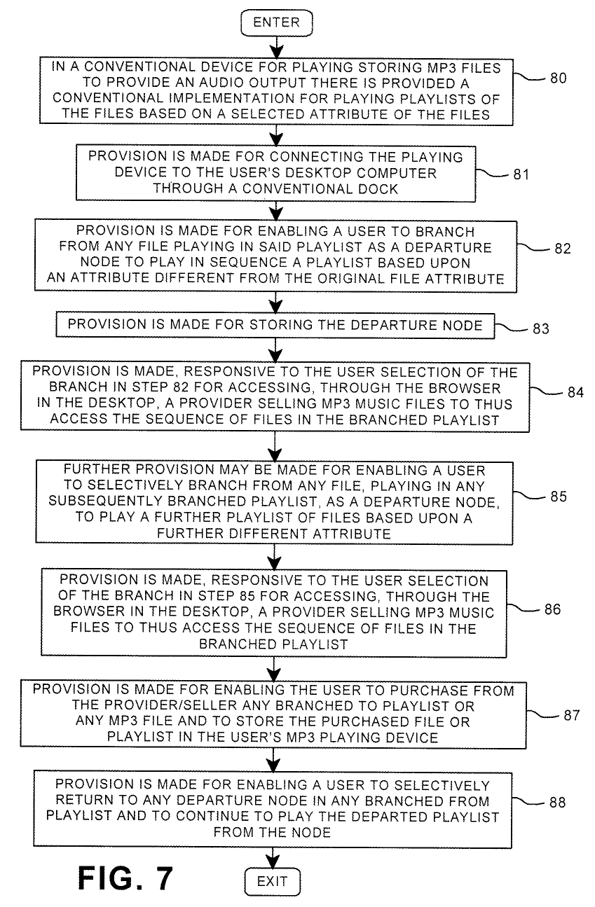

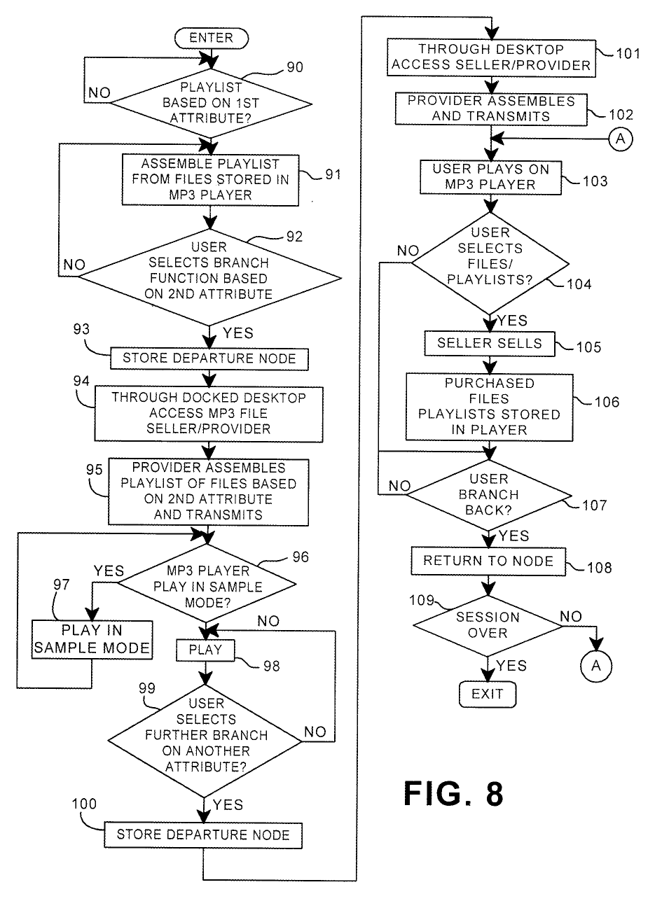

To illustrate a simple operation of the invention including programming that will be described in greater detail with respect to FIGS. 7 and 8, let us refer to FIG. 5. Assume that the user has selected a playlist of MP3 titles or files that are currently being played in sequence. This playlist has been selected from the user's own MP3 files that are currently stored on the user's MP3 player. Thus, the user owns these MP3 files. The playlist in this illustration has been selected based upon an initial attribute, which is “random”, i.e. the system selects and plays MP3 files in a random order. Screen 65 in FIG. 5 shows the MP3 file being currently played and four of its attributes: title of music song 79, artist 67, album 66 and genre 68. At the point that the song is being played, the user/listener may decide to branch off to and pursue a playlist based upon one of the attributes. In the present case, as indicated by arrowhead 69, moved by any method described above, the listener has decided that he would like to listen to a playlist of the artist 67, “Benny Goodman Orch.” To confirm the selection, the program has brought up display screen 65 in FIG. 6 that is the artist menu 70 with the selected artist 72 already indicated by highlighting 73. The user pushes the central button 78 (FIG. 4) to confirm, and the program now commences to put together a playlist that will be acquired from the MP3 file and playlist providers on the Web from which the user will have an opportunity to purchase MP3 files and playlists that suit him. The MP3 player device now commences to play a playlist of the artist that, in effect, branches from the playlist node shown in FIG. 3, but based upon the artist rather than the original random attribute. However, this artist based playlist is accessed from a provider on the Web. Now, when the acquired playlist is sequentially played, display screens such as that of FIG. 5 will be presented for each MP3 file being played. From any one of this sequence of display screens the listener is enabled to buy any of the sequentially played MP3 audio files from the provider by simply pressing the “Buy” button 75. In such a buy situation, the file will be added to the user's permanent collection as synchronized between his desktop and the MP3 player. The buying of MP3 files from providers on the Web is described in the above-referenced text, iPod™+iTunes™ for Windows™ and Mac™ in a Snap, at pp. 94 through 101.

At this point, the user may still pursue another branch to a another playlist based upon another attribute shown in FIG. 3. For example, if after listening to a string of Benny Goodman songs the listener decides that he is really interested in hearing more MP3 files from the “Classical Jazz” 68 genre attribute, the listener proceeds as described above to branch to such a playlist that again is accessed from a MP3 provider on the Web, and may, then, be purchased from the provider. The program tracks all of the playlists, nodes and branches so the listener, through navigation through the interface of FIGS. 4 through 6, may return to any branch node and resume the playing of the switched from playlist.

There is also an option to play the playlists of the branched to MP3 files in a sample mode wherein only a portion of the next file in the playlist is played before the next file in the list. If the user becomes more interested in the playlist, he can then revert to the full play mode.

Provision may also be made to enable the user to base any selected playlist of files upon a set of selected attributes, e.g. “Benny Goodman Orch” 67 and “Classical Jazz”, 68 in FIG. 5.

Provision is available for wirelessly connecting the wireless MP3 player to the desktop computer and, thereby, to the Web through a wireless base station instead of the wired dock. This wireless access point may be referred to as an 802.11 base station, a WiFi hub or any of the wireless devices available for connecting wireless I/O devices to a desktop computer. Such wireless connections are described in the above-referenced text, iPod™+iTunes™ for Windows™ and Mac™ in a Snap, at pp. 228 through 231.

Now with reference to the programming shown in FIG. 7, there will be described how the system and programs of the present invention are set up. In a conventional device for playing stored MP3 files, there is provided a conventional implementation for playing playlists of the files based upon a selected attribute of the files, step 80. Provision is made for connecting the MP3 player to the desktop computer through a conventional dock, step 81. Provision is made for enabling the user/listener to branch from any file playing in the playlist, as a departure node, to play in sequence a playlist based upon an attribute different from the original playlist attribute, step 82. Provision is made for storing and, thus, tracking this departure node, step 83. In response to the user selection of a branch in step 82, provision is made for accessing, through the browser in the desktop, a Web provider selling MP3 music files so as to access the playlist of music files branched to from this provider, step 84. In addition, provision may be made enabling a user to selectively branch from any file playing in any subsequent branched to playlist, as a departure node to play a further playlist of files based upon a further different attribute, step 85. In response to the user selection of a branch in step 85, provision is made for accessing, through the browser in the desktop, a Web provider selling MP3 music files so as to access the playlist of music files branched to from this provider, step 86. Provision is made enabling the user who is listening to a playlist of files accessed from a provider to purchase any MP3 file or playlist of files from the provider and to store such files in the user's MP3 playing device, and also in the desktop computer correlated to the MP3 player, step 87. Provision is made for enabling the user to selectively return to any departure node in any branched from playlist, and to continue to play the departed playlist from the node, step 88.

With reference to the flowchart of FIG. 8, a simplified illustrative run of the process set up in FIG. 7 will be described. An initial determination is made, step 90, as to whether a playlist based upon a first attribute has been requested. If Yes, the playlist is assembled and played, step 91. Then, as the playlist is played, a determination is continually made as to whether the user has selected a playlist branch function based upon another or second attribute, step 92. If No, the playing, step 91, is continued. If Yes, the departure node is stored, step 93, and a playlist based on the second attribute is assembled, as previously described through the desktop computer connected, step 94, to a seller/provider source on the Web. This seller/provider assembles the playlist of MP3 files based upon the second attribute and transmits back to the MP3 player through the desktop computer, step 95. At any point in the playing of the playlist, a determination is made as to whether the user has selected to play the playlist in the sample mode, step 96. If Yes, the playlist is played in the sample mode wherein each MP3 file is played in a shortened mode, step 97. If No, normal play is continued, step 98.

As this next playlist is played, a determination is continually made as to whether the user has selected a further playlist branch function based upon still another attribute, step 99. If No, the playing, step 98, is continued. If Yes, the departure node is stored, step 100, and a playlist based on this further attribute is assembled as previously described through the desktop computer connected, step 101, to a seller/provider source on the Web. This seller/provider assembles the playlist of MP3 files based upon the second attribute and transmits back to the MP3 player through the desktop computer, step 102, which the user plays on his MP3 player, step 103.

As the user is playing the variously assembled playlists of MP3 files accessed from the seller provider, a determination may continuously be made as to whether the user has selected to buy any of the files or playlists, step 104. If Yes, the seller initiates and records the sale for billing in any conventional Web manner, step 105. The purchased MP3 files may then be stored in the MP3 player and in the desktop computer, step 106.

Also, at any point in this process, a determination is continually made as to whether the user wishes to branch back to a departure node, step 107. If Yes, the user is prompted for the entry of the departure node, step 70, and the node is returned to from which the departed playlist is continued to be played, step 108. At any point a determination may also be made as to whether the playing session is at an end, step 109. If Yes, the session is exited. If No, the playing is branched back via branch “A” to step 103 from which the playing continues as heretofore described.

Although certain preferred embodiments have been shown and described, it will be understood that many changes and modifications may be made therein without departing from the scope and intent of the appended claims.

What is claimed is:

1. A computer controlled system in a communications network for accessing and developing a personal library of stored MP3 files comprising:
a computer controlled device for playing stored MP3 files connected to said communications network including:
means for sequentially playing a first playlist of a sequence of a plurality of said stored MP3 files arranged according to an initially selected attribute of said files; and
means enabling a user to select, from an MP3 file being played in said playlist, a second attribute of said MP3 file different from said initially selected attribute;
means for accessing from a source in said communications network a second playlist of a sequence of stored MP3 files arranged according to said second attribute;
means for branching from said MP3 file being played, as a departure node, to play said second playlist;
means for storing said departure node; and
means for enabling the user to return to said departure node to continue the playing of said first playlist from said departure node.

2. The computer controlled system of claim 1 further including means for selectively playing said second playlist in a sample mode wherein only a portion of each sequential MP3 file is played.

3. The computer controlled system of claim 1 further including:
means enabling a user to select, from an MP3 file being played in said second playlist, a third attribute of said MP3 file different from said second attribute;
means for accessing from a source in said communications network a third playlist of a sequence of a stored MP3 file arranged according to said third attribute;
means for branching from said MP3 file being played in said second playlist, as a departure node, to play said third playlist;
means for storing said departure node in said second playlist; and
means for enabling the user to return to said departure node in said second playlist to continue the playing of said second playlist from said departure node.

4. The computer controlled system of claim 1 wherein said source from which said second playlist is accessed is a library of MP3 files maintained by a provider selling MP3 files.

5. The computer controlled system of claim 4 wherein said communications network is the World Wide Web.

6. The computer controlled system of claim 5 wherein said MP3 files are audio files, and said means for playing are audio.

7. The computer controlled system of claim 6 wherein the computer controlled device for playing stored MP3 files is a desktop computer.

8. A method for developing, in a compressed audio file player, a personal library of stored compressed audio files accessed from a communications network comprising:
sequentially playing, in said compressed audio file player, a first playlist of a sequence of a plurality of stored compressed audio files arranged according to an initially selected attribute of said files;
enabling a user to select, from a compressed audio file being played in said playlist, a second attribute of said compressed audio file different from said initially selected attribute;
accessing from a source in said communications network a second playlist of a sequence of stored audio files arranged according to said second attribute;
branching from said compressed file being played, as a departure node, to play said second playlist;
storing said departure node; and
enabling the user to return to said departure node to continue the playing of said first playlist from said departure node.

9. The method of claim 8 wherein said compressed audio files are MP3 files.

10. The method of claim 9 further including the step of selectively playing said second playlist in a sample mode wherein only a portion of each sequential MP3 file is played.

11. The method of claim 9 further including the step of:
enabling a user to select, from an MP3 file being played in said second playlist, a third attribute of said MP3 file different from said second attribute;
accessing from a source in said communications network a third playlist of a sequence of stored MP3 files arranged according to said third attribute;
branching from said MP3 file being played in said second playlist, as a departure node, to play said third playlist;
storing said departure node in said second playlist; and
enabling the user to return to said departure node in said second playlist to continue the playing of said second playlist from said departure node.

12. The method of claim 9 wherein said first and second attributes, each include a set of a plurality of attributes.

13. The method of claim 9 wherein said source from which said second playlist is accessed is a library of MP3 files maintained by a provider selling MP3 files.

14. The method of claim 13 wherein said communications network is the World Wide Web.

15. A computer program having code recorded on a computer readable medium for developing, in a compressed media player, a personal library of stored compressed media files accessed from a communications network comprising:
means for sequentially playing, in said compressed media player, a first playlist of a sequence of a plurality of said stored compressed media files arranged according to an initially selected attribute of said files;
means enabling a user to select, from a compressed media file being played in said playlist, a second attribute of said compressed media files different from said initially selected attribute;
means for accessing from a source in said communications network a second playlist of a sequence of stored compressed media files arranged according to said second attribute;
means for branching from said compressed media file being played, as a departure node, to play said second playlist;
means for storing said departure node; and
means for enabling the user to return to said departure node to continue the playing of said first playlist from said departure node.

16. The computer program of claim 15 wherein said compressed media player is an MP3 file player.

17. The computer program of claim 16 further including means for selectively playing said second playlist in a sample mode wherein only a portion of each sequential MP3 file is played.

18. The computer program of claim 16 further including:
means enabling a user to select, from an MP3 file being played in said second playlist, a third attribute of said MP3 file different from said second attribute;
means for accessing from a source in said communications network a third playlist of a sequence of stored MP3 files arranged according to said third attribute;
means for branching from said MP3 file being played in said second playlist, as a departure node, to play said third playlist;
means for storing said departure node in said second playlist; and
means for enabling the user to return to said departure node in said second playlist to continue the playing of said second playlist from said departure node.

19. The computer program of claim 16 wherein said first and second attributes, each include a set of a plurality of attributes.

20. The computer program of claim 16 wherein said source from which said second playlist is accessed is a library of MP3 files maintained by a provider selling MP3 files.

21. The computer program of claim 16 wherein said communications network is the World Wide Web.

22. The computer program of claim 20 wherein the computer controlled device for playing stored MP3 files is a portable device.
